(19) United States
(12) Patent Application Publication
(10) Pub. No.: US 2025/0028515 A1
(43) Pub. Date: Jan. 23, 2025

(54) HORIZONTAL SCALING OF LEGACY CONTROLLED SOFTWARE

(71) Applicant: Welch Allyn, Inc., Skaneateles Falls, NY (US)

(72) Inventors: Bernard Cecchini, Auburn, NY (US); William Cumming, River Hills, WI (US); Glenn A. Packer, Earlville, NY (US)

(21) Appl. No.: 18/778,069

(22) Filed: Jul. 19, 2024

Related U.S. Application Data
(60) Provisional application No. 63/528,022, filed on Jul. 20, 2023.

(51) Int. Cl. G06F 8/61; G06F 8/658; G06F 9/455

(52) U.S. Cl. CPC G06F 8/63; G06F 8/658; G06F 9/455

(57) ABSTRACT

An example system and method are described to provide automated pipelines used to build a horizontally scaled computing system for legacy controlled software. In existing systems, many legacy software implementations cannot be re-worked or redesigned to horizontally scale, for example to implement in a cloud computing environment or implementation of virtual machines. The systems and methods described herein provide a pipeline to take legacy web-based software deployed on traditional servers and increase performance and security while maintaining configuration control and minimizing code changes to the legacy application.

### RELATED APPLICATIONS

This application claims priority to U.S. Provisional Patent Application No. 63/528,022, filed on Jul. 20, 2023, the entire contents of which are incorporated herein by reference.

### TECHNICAL FIELD

This application relates generally to horizontal scaling of legacy web-based software deployed on traditional servers while maintaining configuration control and minimizing code changes to the legacy application.

### BACKGROUND

Continuous integration (CI) is a software development practice in which adjustments to the underlying code in an application are tested as team members or developers make changes. CI speeds up the release process by enabling teams to find and fix bugs earlier in the development cycle and encourages stronger collaboration between developers. Continuous deployment (CD) is the process of getting new software builds to users as quickly as possible. It is the natural next step beyond CI and is an approach used to minimize the risks associated with releasing software and new features. As software development teams attempt to meet growing demand for faster release and increased quality and security of software, many look to a continuous development pipeline to streamline the process. Adopting a continuous integration and continuous deployment (CICD) approach allows for on-demand adaption of software and improvements in time to market, testing automation, security, and user satisfaction.

In healthcare, data-driven technology solutions are being developed to further personalized healthcare all while reducing costs. With the healthcare landscape shifting to an on-demand deployment system of personalized medical services and solutions, healthcare providers are looking to developers for help with innovating solutions faster through automating and streamlining the software development and service management processes. In order to support healthcare providers and services, developers have looked to distributed computing environments (e.g., cloud computing) as the healthcare information technology infrastructure standard, which is a low-cost way to develop the complex infrastructure required to support the continuous development pipeline and deployment of software within a service model (e.g., analytics-as-a-service (AaaS)). While distributed computing environments such as cloud computing afford healthcare providers many benefits, they function differently than legacy storage or information sharing solutions, and thus create their own unique privacy and security challenges. For example, because users access data through an internet connection, government regulation (e.g., Health Insurance Portability and Accountability Act (HIPAA), “good practice” quality guidelines and regulations (GxP), and General Data Protection Regulation (GDPR) compliance becomes a unique challenge for healthcare providers looking into cloud solutions to support the continuous development pipeline and deployment of software. Accordingly, there is a need for advances in compliant software development platforms, built to ensure the confidentiality, availability and integrity of protected healthcare information.

### SUMMARY

Various implementations of the present disclosure relate to techniques for scaling of legacy medical software subject to quality control systems while maintaining configuration control and minimizing code changes to the legacy application.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method. The method includes generating a software build artifact by using a first automated pipeline, the software build artifact may include a build file of a legacy software package that operates in a first computing environment. The method also includes generating a release artifact by using a second automated pipeline, the release artifact may include a configuration of a server system in a second computing environment. The method also includes installing the software build artifact on the release artifact to generate a picture of the legacy software on the server system. The picture may refer to a snapshot of the legacy software as a server image. The method also includes hosting the legacy software through a virtual machine scale set by deploying one or more instances of the picture in a target computing environment. Other embodiments of this aspect include corresponding computer systems, apparatus, and computer programs recorded on one or more computer storage devices, each configured to perform the actions of the methods.

Implementations may include one or more of the following features. The method where the legacy software package is subject to one or more quality control systems (QCS) and alterations to underlying code of the legacy software package are limited by the QCS. Generating the software build artifact may include maintaining configuration control of the legacy software without changes that would violate a quality control system (QCS). The first computing environment may include a local server computing environment. The target computing environment may include a cloud computing environment. The legacy software is executed on a legacy virtual machine in the first computing environment and where hosting the legacy software may include hosting multiple instances of the legacy software in an operating plane. The operating plane is managed by an application gateway that creates instances of the picture. The instances of the picture are hosted in a virtual machine scale set to provide parallel processing and computing power for the legacy software. Implementations of the described techniques may include hardware, a method or process, or computer software on a computer-accessible medium.

### DESCRIPTION OF THE FIGURES

The following figures, which form a part of this disclosure, are illustrative of described technology and are not meant to limit the scope of the claims in any manner.

FIG. 1 illustrates an example of pipelines used to build the horizontally scaled computing system for legacy controlled software.

FIG. 2 illustrates an example of an implementation of the systems described herein for horizontal scaling of legacy software.

FIG. 3 illustrates an example process for generating a host cloud-based computing environment from legacy software.

FIG. 4 illustrates an example process for implementing horizontal scaling of legacy software subject to quality control systems.

FIG. 5 illustrates a block diagram of a computing system, according to some embodiments.

FIG. 6 illustrates a cloud computing system, according to some embodiments.

### DETAILED DESCRIPTION

Various implementations of the present disclosure will be described in detail with reference to the drawings, wherein like reference numerals present like parts and assemblies throughout the several views. Additionally, any samples set forth in this specification are not intended to be limiting and merely set forth some of the many possible implementations.

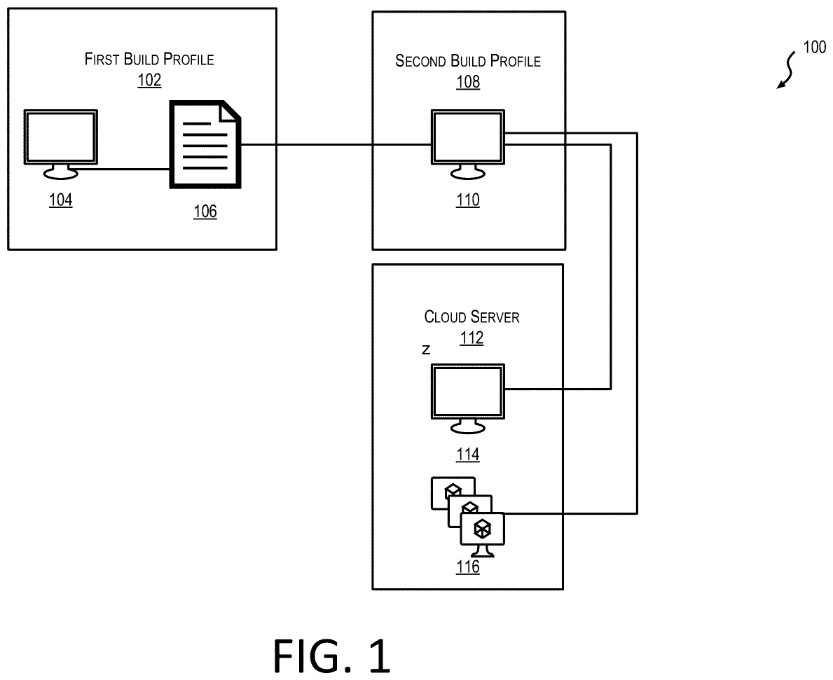

FIG. 1 illustrates an example of pipelines used to build the horizontally scaled computing system for legacy controlled software. In existing systems, many legacy software implementations cannot be re-worked or redesigned to horizontally scale, for example to implement in a cloud computing environment or implementation of virtual machines. Horizontal scaling refers to adding or removing instances of a resource whenever a high availability of services (e.g., server-based service) are needed. Scaling horizontally typically includes adding additional processing units or systems to a server, database, system, or environment. The system 100 of FIG. 1 provides a pipeline to take legacy web-based software deployed on traditional servers and increase performance and security while maintaining configuration control and minimizing code changes to the legacy application.

The system 100 uses infrastructure changes to alter the architecture of the computing environment in a manner that enables horizontal scalability of a software program while minimizing changes to the code and to the user experience of the legacy application. The minimizing of changes to code may ensure that the system remains in compliance with one or more quality control systems or regulations, for example for medical-based systems and implementations.

A first pipeline is used to generate a first build profile 102 from an agent 104 running the legacy software. The first pipeline builds a software artifact 106 of legacy software that may be used to produce an image to be consumed by other pipelines to automate generation of scaled sets of virtual machines through the use of a final virtual machine image. A second pipeline is used to generate a second build profile 108 that produces a base image 110 of a host system for running the software.

The present description describes techniques for CICD of source code on a digital health platform. More specifically, embodiments of the present disclosure provide techniques for validating and deploying various classes of code (e.g., software as a medical device) in accordance with a quality management system that defines a set of requirements for validating the various classes of source code.

Cloud platform-based systems are used for continuous integration/continuous delivery of software artifacts. CICD is a software engineering approach in which teams produce software in short cycles, ensuring that the software can be reliably released at any time and, when releasing the software, doing so manually. It aims at building, testing, and releasing software with greater speed and frequency. The approach may help reduce the cost, time, and risk of delivering changes by allowing for more incremental updates to applications in production. Continuous delivery may correspond with a repeatable deployment process. The CD tools may comprise, for example, Buddy®, JBoss®, Tomcat®, HUDSON®, Ant®, Rakc®, Maven®, Crucible®, Fisheye®, Jenkins®, Puppet®, Chef®, Sonatype® Nexus®, JIRA®, Eucalyptus® and git/svn (“Subversion” Version Control Software)/Perforce®.

Continuous integration (CI) is a software development practice in which adjustments to the underlying code in an application are tested as team members or developers make changes. CI speeds up the release process by enabling teams to find and fix bugs earlier in the development cycle and encourages stronger collaboration between developers. Continuous deployment (CD) is the process of getting new software builds to users as quickly as possible. It is the natural next step beyond CI and is an approach used to minimize the risks associated with releasing software and new features. As software development teams attempt to meet growing demand for faster release and increased quality and security of software, many look to a continuous development pipeline to streamline the process. Adopting a continuous integration and continuous deployment (CICD) approach allows for on-demand adaption of software and improvements in time to market, testing automation, security, and user satisfaction.

In order to support healthcare providers and services, developers have looked to distributed computing environments (e.g., cloud computing) as the healthcare information technology infrastructure standard, which is a low-cost way to develop the complex infrastructure required to support the continuous development pipeline and deployment of software within a service model (e.g., analytics-as-a-service (AaaS)). While distributed computing environments such as cloud computing afford healthcare providers many benefits, they function differently than legacy storage or information sharing solutions, and thus create their own unique privacy and security challenges. For example, because users access data through an internet connection, government regulation (e.g., Health Insurance Portability and Accountability Act (HIPAA), “good practice” quality guidelines and regulations (GxP), and General Data Protection Regulation (GDPR) compliance becomes a unique challenge for healthcare providers looking into cloud solutions to support the continuous development pipeline and deployment of software. Accordingly, there is a need for advances in compliant software development platforms, built to ensure the confidentiality, availability and integrity of protected healthcare information.

The systems and techniques described herein use infrastructure changes to enable horizontal scalability while minimizing changes to code of existing applications for healthcare settings while minimizing or preventing changes to the code and user experience with the legacy application. By using CICD, software and virtual machine base images are built and then used to produce a final virtual machine image that includes a host system and software application. The output of the systems and techniques provides for a unique configuration control version that allows and enables freezing a software element and/or recreating software at a particular time and/or version as well as to provide patches.

The virtual machines produces by the system described herein enable spinning up multiple virtual machines that host the legacy software application as well as provide load balancing capabilities. Finally, a gateway provides security by detecting and mitigating security risks and routes traffic using end-to-end encryption within the virtual scale set.

A Quality Control System (QCS) is a set of interrelated or interacting elements such as policies, objectives, procedures, processes, and resources that are established individually or collectively to guide an organization. In the context of this disclosure, organizations engaged in data-driven technology solutions on a digital health platform should establish, implement, monitor, and maintain a QCS that helps them ensure they meet consumers and other stakeholder needs within statutory and regulatory requirements related to a software product, service, or system. This includes verification and validation of code for checking that a software product, service, or system meets requirements and that it fulfills its intended purpose.

A requirement can be any need or expectation for a system or for its software. Requirements reflect the stated or implied needs of the consumer, and may be market-based, contractual, or statutory, as well as an organization's internal requirements. There can be many different kinds of requirements (e.g., design, functional, implementation, interface, performance, or physical requirements). Software requirements are typically derived from the system requirements for those aspects of system functionality that have been allocated to software. Software requirements are typically stated in functional terms and are defined, refined, and updated as a development project progresses.

In an example, Continuous Integration/Continuous Delivery (CICD) is used to build the software artifact 106 and the Virtual Machine (VM) base images 110 that are consumed to produce a final VM image that contains the host system and software application. The output of these pipelines provide a unique configuration control version allowing ability to freeze and recreate what the software looked like at a particular point-in-time and provide patches.

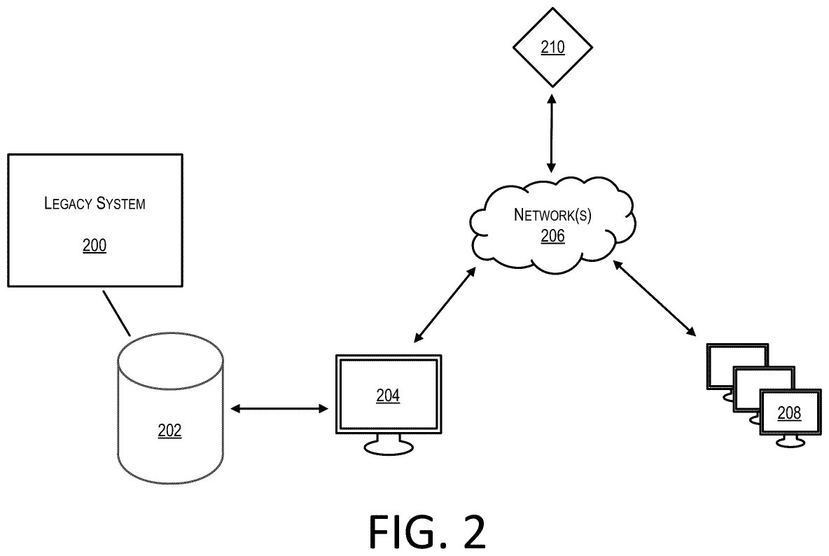

In a hosting environment 112, the virtual machine 114 may be running alongside a virtual machine scale set 116. The virtual machine scale set 116 manages the capability to spin up multiple virtual machines that host the legacy application along with load balancing capabilities to distribute computing load as-needed. Additionally, an application gateway, shown in FIG. 2, provides a layer of security by acting as a gatekeeper to detect and mitigate security issues and to route traffic using end-to-end encryption with the virtual machine scale set 116.

The techniques described herein minimize changes to the existing legacy application leading to a shorter timeframe to market and less of a resource investment. The way the virtual machines are built and controlled in an automated fashion (e.g., using the first pipeline and the second pipeline) allows for the configuration control required by many regulatory bodies for medical software. Additionally, end-to-end encryption can be implemented to protect Private Health Information (PHI) and Personal Identifiable Information (PII) between the different layers of the solution.

By utilizing infrastructure system described herein, for example including the hosting environment with the virtual machine scale set 116, the system is capable of changing the solution architecture in a way to achieve horizontal scalability while minimizing changes to the code and user experience of the legacy application. Further, the automated pipelines used to create the software artifact 106 and the base image can be implemented in an automated manner for any number of legacy applications. This results in reduced time, cost, and failure due to manual intervention to create, deploy, and control the software and server state.

In examples, the methods described herein provide for generating a software build artifact by using a first automated pipeline, the software build artifact may include a build file of a legacy software package that operates in a first computing environment. The first automated pipeline may include a build pipeline. A pipeline as used herein refers to a continuous delivery process be constructed from a series of jobs that each carry out the atomic tasks that are required to take the software from source code to running application or shippable artefact. These jobs are orchestrated through a pipeline, which will control the ordering of job execution, manage branching and associated functions such as error recovery. A build as used herein refers to an instance of a job execution (e.g., the results thereof). The build pipeline provides tasks to build, test, and deploy applications. The method further provides for generating a release artifact by using a second automated pipeline that may include a release pipeline. While the first automated pipeline is used to generate artifacts from source code of the legacy software product, a release pipeline consumes the artifacts and conducts follow-up actions within a multi-staging system. The artifact may include a configuration of a server system in a second computing environment such as a cloud-based or other such computing environment. The method further includes installing the software build artifact on the release artifact to generate a picture of the legacy software on the server system. In this manner, the method provides for hosting the legacy software through a virtual machine scale set by deploying one or more instances of the picture in a target computing environment. The virtual machine scale set enables creation and management of a group of load balanced VMs. The number of VM instances can automatically increase or decrease in response to demand or a defined schedule. The scale set may have up to 1,000 virtual machines. To provide for additional scalability, the target computing environment may initiate additional instances of the legacy software through the virtual machine scale set.

FIG. 2 illustrates an example of an implementation of the systems described herein for horizontal scaling of legacy software. In the implementation, the legacy system 200 is operating on an existing server in a web-based system. The legacy system 200 may include, for example, healthcare-centric software that is used and includes particular safety, security, and encryption protocols. Such protocols may be tightly controlled and/or regulated in such a way that may prevent or make updates to enable horizontal scaling or enable cloud-based environments difficult to implement due to regulatory reasons and controls and/or software approvals. As healthcare software is typically controlled regulated to ensure safety, privacy, and stability, changes that may impact the software may take significant time to implement and receive approval for rollout and use. Accordingly, the systems and methods described herein provide for horizontal scaling of the legacy system 200 to provide additional capabilities and resources that may not be possible in the legacy system that is a web-based system. Accordingly, the legacy system 200 may be stored on a server drive 202 and executed in a virtual legacy machine 204.

Using automated pipelines such as a build pipeline and a release pipeline, a build artifact and base image are generated from the legacy system 200. The build pipeline provides tasks to build, test, and deploy applications. The method further provides for generating a release artifact by using a second automated pipeline that may include a release pipeline. While the first automated pipeline is used to generate artifacts from source code of the legacy software product, a release pipeline consumes the artifacts and conducts follow-up actions within a multi-staging system.

The build artifacts include files that are produced by a step. Once the artifacts are defined in the build pipeline, they can be shared or exported. Artifacts, either build artifacts or release artifacts, include any kind of file that the pipelines produce. An artifact from the build pipeline, a build artifact, can be published and downloaded. The build artifacts can be consumed in the same pipeline and/or in other pipelines, such as the release pipeline. In an example, a build artifact can be in the form of a compressed file, archive file, or package. Each build artifact can be associated with a particular commit hash string (or identifier) corresponding to the committed code that was utilized to generate the build artifact. The build artifact may be stored at a cloud storage platform after being generated.

The release artifacts include filed produced by the release pipeline. With a CICD pipeline, a software release artifact can move and progress through the pipeline from the code check-in stage through the test, build, deploy, and production stages. Although it is possible to manually execute individual steps of a CI/CD pipeline, a significant advantage of CI/CD pipelines is achieved through automation, which can speed the process and reduce errors, thus making it possible for enterprises to deliver incremental software update frequently (e.g., weekly, daily, hourly, etc.) and reliably. The release pipeline consumes the artifacts and conducts follow-up actions within a multi-staging system. The artifact may include a configuration of a server system in a second computing environment such as a cloud-based or other such computing environment. The release artifact may include a configuration of a server system in a second computing environment. The software build artifact may be used to produce the release artifact to generate a picture of the legacy software on the server system. The picture may refer to a snapshot of the legacy software as a server image.

The virtual machine 204 connects over a network 206 with a virtual machine scale set 208. to provide horizontal scalability. The network 206 may include any suitable network connections and/or systems including, for example, the internet and other such networks.

The virtual machine scale set 116 manages the capability to spin up multiple virtual machines that host the legacy application along with load balancing capabilities to distribute computing load as-needed. A computing cluster can support the virtual machine scale set 208 (e.g., availability set or virtual machine scale set) that is a logical grouping of virtual machine instances. An availability set can specifically refer to a set of virtual machine instances that are assigned to a single cluster-tenant (e.g., 1:1 relationship) and a virtual machine scale set can refer to a set of virtual machine instances that are assigned to multiple cluster-tenants. In this context, an availability set can be a subset of a virtual machine scale set. Additionally, an application gateway 210 provides a layer of security by acting as a gatekeeper to detect and mitigate security issues and to route traffic using end-to-end encryption with the virtual machine scale set 208.

The virtual machine scale set 208 enables creation and management of a group of load balanced VMs. The number of VM instances can automatically increase or decrease in response to demand or a defined schedule. The scale set may have up to 1,000 virtual machines. To provide for additional scalability, the target computing environment may initiate additional instances of the legacy software through the virtual machine scale set.

The virtual machine scale set 208 may include compute instances. A compute instance such as a virtual machine may be instantiated at a virtualization host of the service on behalf of a client, and allocated a set of resources (e.g., CPUs, memory, storage, etc.), based for example on a resource specification of a particular category of a set of pre-defined instance categories of the service. A scaling (or automatic scaling, “autoscaling”) policy used by the system may be referred to in various embodiments as a scaling rule, autoscale rule, autoscaling rule, or autoscaling configuration. A set (e.g., one or more) of compute instances managed by such a scaling policy can be referred to in various embodiments as an autoscaling group, scaling group, virtual machine scale set, auto scale instance group, managed instance group, instance pool, or backend set.

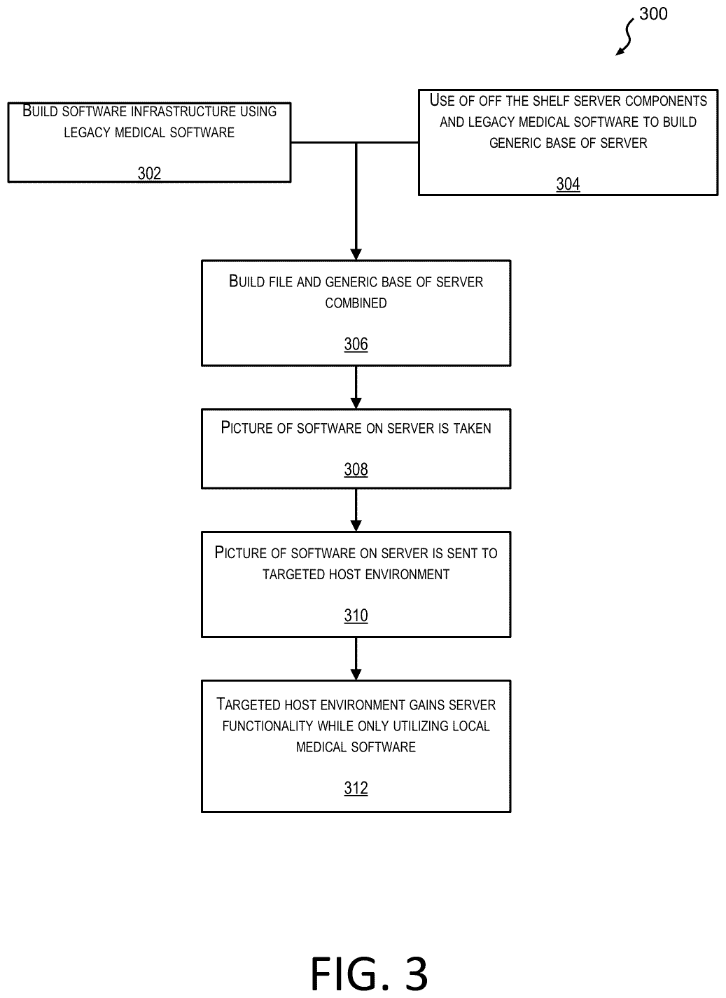

FIG. 3 illustrates an example process 300 for generating a host cloud-based computing environment from legacy software. The process 300, as well as the additional processes discussed herein, may be implemented in hardware, software, or a combination thereof. In the context of software, the described operations represent computer-executable instructions stored on one or more computer-readable storage media that, when executed by one or more hardware processors, perform the recited operations. Generally, computer-executable instructions include routines, programs, objects, components, data structures, and the like that perform particular functions or implement particular abstract data types. Those having ordinary skill in the art will readily recognize that certain steps or operations illustrated in the figures may be eliminated, combined, or performed in an alternate order. Any steps or operations may be performed serially or in parallel. Furthermore, the order in which the operations are described is not intended to be construed as a limitation.

At step 302 source code validated with a QCS from a software development system is accessed and used to build a software artifact (e.g., software infrastructure). The source code is accessed from a CI/CD system of a software platform. In some instances, the software development system is located remotely over a network connection from the CI/CD system. The QCS defines a first set of requirements for validating the source code. In some instances, the set of requirements is adapted to determine one or more of the following: whether the source code conforms to an intended use, performs as intended to implement the intended use, and satisfies a base level of security. The QCS is customized for handling broad challenges faced by software developers in developing quality source code, e.g., defined to ensure a software developer meets consumers and other stakeholder needs related to a software product, service, or system. This includes verification and validation of code for checking that a software product, service, or system meets the first set of requirements.

In building the software artifact, a profile for the source code is generated. The profile is generated by: (i) identifying characteristics of the source code and characteristics of data operated on by the code, and (ii) building the profile using the characteristics of the source code and the characteristics of the data operated on by the code. The characteristics of the source code may be identified by analyzing scope of source code comments on the source code and by analyzing the technology used by the code (e.g., Java or mobile platforms). The characteristics of the source code may include one or more programming languages used to write the source code, intended use of the source code, environment in which the source code is intended to run, environment in which the source code was developed (e.g., country of origin), and the like. The characteristics of the data operated on by the source code may include type and format of data to be input to the source code and type of data and format generated by the source code. For example, type and format may include whether the data is streaming data, model training data, data with integrity and privacy concerns, data compiled from SAMD, historical or archived data, and the like.

The build process is executed to generate a executable program from the source code and perform version control of the executable program. The version control may include identifying a version of the source code based on the static analysis and generating an executable program version that includes the source code based on the identified version of the source code. The version control may further include managing the activation and visibility of the executable program version and/or older executable program versions including the source code.

At 304, an off-the-shelf server configuration and component is used with the software artifact (build profile) to build a generic base of a server. The generic base of the server may include a server and runtime implementation of base server tooling that can adjust its behavior by a server type definition file.

At 306, the software build file and the generic base of the server are combined to produce an instance of the legacy software operating on the generic base of the server. The instance of the legacy software on the generic base may be representative of the existing legacy system for a particular software product.

At 308 a picture of the software on the server (now configured) is taken. The picture may refer to a snapshot of the legacy software as a server image. The snapshot may be taken at various releases and/or builds to enable selection of particular versions of legacy software to be selected, scaled, and used by the system. The snapshot may include various patches or other software changes or adjustments that may be used or implemented on the legacy software.

At 310 the picture is sent to a target host environment. The picture, including the snapshot of the legacy software taken at 308 may be sent to a particular target host environment such as a virtual machine scale set or other such environment for deployment of the instances of the legacy software.

And finally, at step 312 the target host environment gains server functionality, horizontal scalability, and the ability to control instances of the picture used to produce the virtual machine scale set. The target host environment enables deployment of multiple instances of the legacy software to provide horizontal scalability of the legacy software at the particular picture.

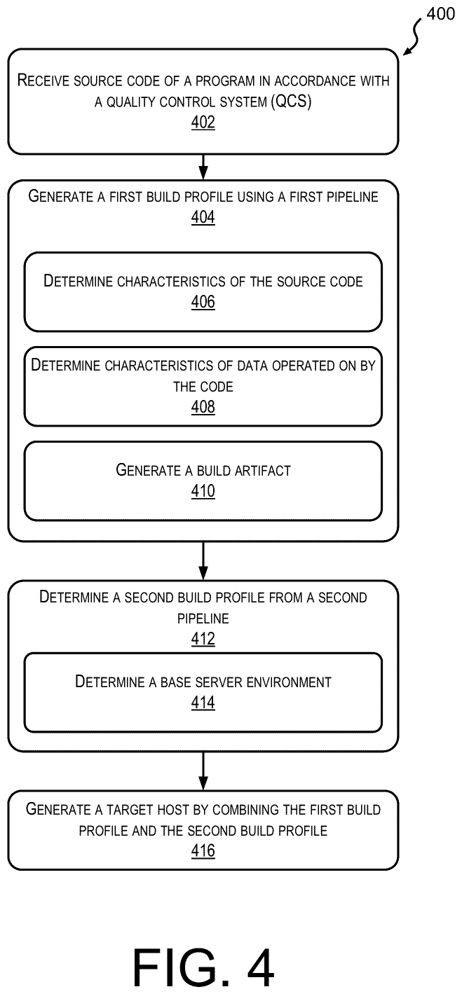

FIG. 4 illustrates an example process 400 for implementing horizontal scaling of legacy software subject to quality control systems.

The process 400 begins at 402 by receiving source code of a program in accordance with a quality control system. The quality control system may prevent re-working of the program to work in a horizontally scalable environment, such as a virtual machine environment and/or cloud-based computing arrangement.

At 404 the process 400 includes generating a first build profile using a first pipeline.

The first pipeline may be an automated system that determines characteristics of the source code of the program at 406, determines characteristics of data operated on by the code at 408, and generates a build artifact 410 representing the program based on the source code. The build artifact may be used to build and/or install the program as-configured in the legacy arrangement.

At 412, the process 400 includes determining a second build profile from a second pipeline. The second build profile may include determination of a base server environment at 414 that may be used to run an instance of the program based on the build artifact. The base server environment may replicate or represent the environment where the program is configured to operate in the legacy system. By combining the base server environment with the build artifact, a picture may be generated that represents an instance of the program running in a virtual environment. The process 400 may then include, at 416, generating a target host by combining the first build profile and the second build profile (e.g., installing the build artifact on the base server). Afterwards, in a hosting environment, the picture generated by combining the build artifact and the base server may be duplicated repeatedly as-needed to provide horizontal scalability through a virtual machine scale set, as described herein.

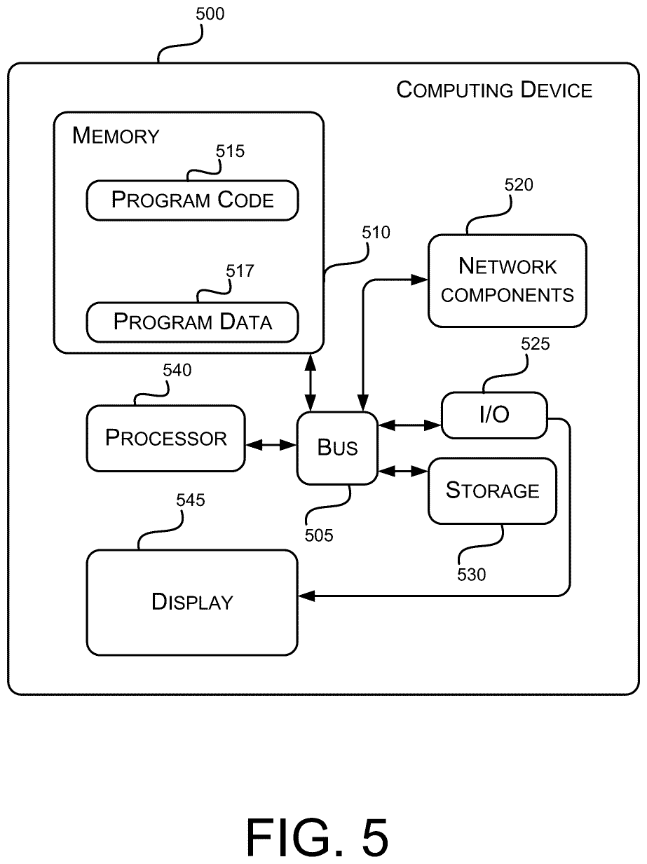

FIG. 5 illustrates a block diagram of an example of a computing device 500 that may be used to implement one or more of the techniques described herein.

The computing device 500 can include a processor 540 interfaced with other hardware via a bus 505. A memory 510, which can include any suitable tangible (and non-transitory) computer readable medium, such as RAM, ROM, EEPROM, or the like, can embody program components (e.g., program code 515) that configure operation of the computing device 500. Memory 510 can store the program code 515, program data 517, or both. In some examples, the computing device 500 can include input/output (“I/O”) interface components 525 (e.g., for interfacing with a display 545, keyboard, mouse, and the like) and additional storage 530.

The computing device 500 executes program code 515 that configures the processor 540 to perform one or more of the operations described herein. Examples of the program code 515 include, in various embodiments logic flowchart described with respect to FIG. 1 above. The program code 515 may be resident in the memory 510 or any suitable computer-readable medium and may be executed by the processor 540 or any other suitable processor.

The computing device 500 may generate or receive program data 517 by virtue of executing the program code 515. For example, sensor data, trip counter, authenticated messages, trip flags, and other data described herein are all examples of program data 517 that may be used by the computing device 500 during execution of the program code 515.

The computing device 500 can include network components 520. Network components 520 can represent one or more of any components that facilitate a network connection. In some examples, the network components 520 can facilitate a wireless connection and include wireless interfaces such as IEEE 802.11, BLUETOOTH™, or radio interfaces for accessing cellular telephone networks (e.g., a transceiver/antenna for accessing CDMA, GSM, UMTS, or other mobile communications network). In other examples, the network components 520 can be wired and can include interfaces such as Ethernet, USB, or IEEE 1394.

Although FIG. 5 depicts a computing device 500 with a processor 540, the system can include any number of computing devices 500 and any number of processor 540. For example, multiple computing devices 500 or multiple processor 540 can be distributed over a wired or wireless network (e.g., a Wide Area Network, Local Area Network, or the Internet). The multiple computing devices 500 or multiple processor 540 can perform any of the steps of the present disclosure individually or in coordination with one another.

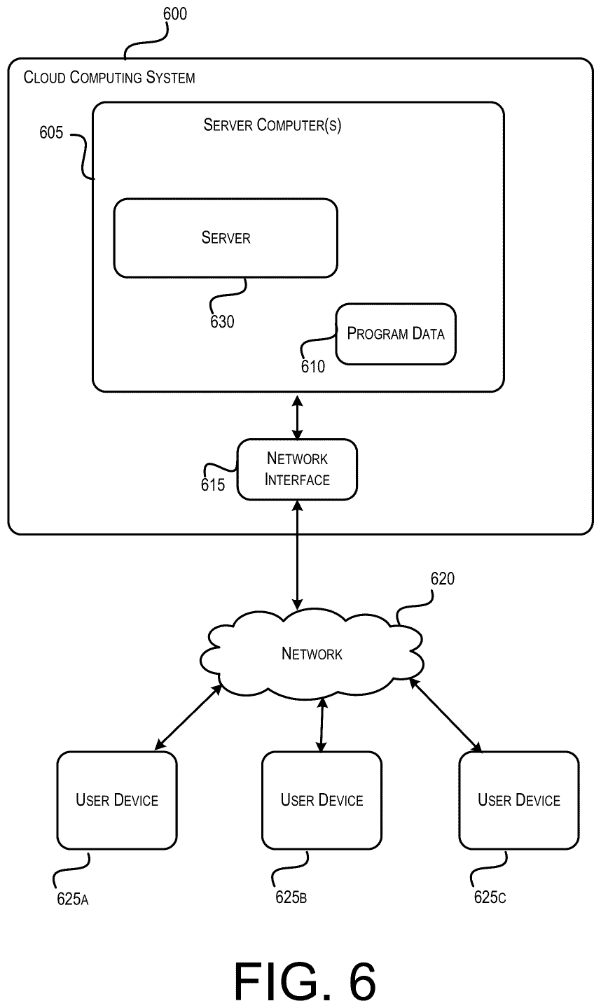

In some embodiments, the functionality provided by the computing device 600 may be offered as cloud services by a cloud service provider. For example, FIG. 6 depicts an example of a cloud computing system 600 offering an intelligence service that can be used by a number of user subscribers using user devices 625a, 625b, and 625c across a data network 620. User devices 625a, 625b, and 625c could be examples of a distributed computing system described above. In the example, the intelligence service may be offered under a Software as a Service (SaaS) model. One or more users may subscribe to the intelligence service, and the cloud computing system performs the processing to provide the intelligence service to subscribers. The cloud computing system may include one or more remote server computers 605.

The remote server computers 605 include any suitable non-transitory computer-readable medium for storing program code (e.g., server 630) and program data 610, or both, which is used by the cloud computing system 600 for providing the cloud services. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript. In various examples, the server computers 605 can include volatile memory, non-volatile memory, or a combination thereof.

One or more of the server computers 605 execute the program data 610 that configures one or more processors of the server computers 605 to perform one or more of the operations that determine locations for interactive elements and operate the adaptive rule-based system. As depicted in the embodiment in FIG. 6, the one or more server computers 605 provide the services to perform the adaptive rule-based system via the server 630. Any other suitable systems or subsystems that perform one or more operations described herein (e.g., one or more development systems for configuring an interactive user interface) can also be implemented by the cloud computing system 600.

In certain embodiments, the cloud computing system 600 may implement the services by executing program code and/or using program data 610, which may be resident in a memory device of the server computers 605 or any suitable computer-readable medium and may be executed by the processors of the server computers 605 or any other suitable processor.

In some embodiments, the program data 610 includes one or more datasets and models described herein. Examples of these datasets include classification data, etc. In some embodiments, one or more of data sets, models, and functions are stored in the same memory device. In additional or alternative embodiments, one or more of the programs, data sets, models, and functions described herein are stored in different memory devices accessible via the data network 620.

The cloud computing system 600 also includes a network interface device 615 that enable communications to and from cloud computing system 600. In certain embodiments, the network interface device 615 includes any device or group of devices suitable for establishing a wired or wireless data connection to the data networks 620. Non-limiting examples of the network interface device 615 include an Ethernet network adapter, a modem, and/or the like. The server 630 is able to communicate with the user devices 625a, 625b, and 625c via the data network 620 using the network interface device 615.

While the present subject matter has been described in detail with respect to specific aspects thereof, it will be appreciated that those skilled in the art, upon attaining an understanding of the foregoing, may readily produce alterations to, variations of, and equivalents to such aspects. Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter. Accordingly, the present disclosure has been presented for purposes of example rather than limitation, and does not preclude the inclusion of such modifications, variations, and/or additions to the present subject matter as would be readily apparent to one of ordinary skill in the art

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for case of explanation only and are not meant to be limiting.

Aspects of the methods disclosed herein may be performed in the operation of such computing devices. The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general-purpose computing apparatus to a specialized computing apparatus implementing one or more aspects of the present subject matter. Any suitable programming, scripting, or other type of language or combinations of languages may be used to implement the teachings contained herein in software to be used in programming or configuring a computing device. The order of the blocks presented in the examples above can be varied—for example, blocks can be re-ordered, combined, and/or broken into sub-blocks. Certain blocks or processes can be performed in parallel.

In some instances, one or more components may be referred to herein as “configured to,” “configurable to,” “operable/operative to,” “adapted/adaptable,” “able to,” “conformable/conformed to,” etc. Those skilled in the art will recognize that such terms (e.g., “configured to”) can generally encompass active-state components and/or inactive-state components and/or standby-state components, unless context requires otherwise.

As used herein, the term “based on” can be used synonymously with “based, at least in part, on” and “based at least partly on.”

As used herein, the terms “comprises/comprising/comprised” and “includes/including/included,” and their equivalents, can be used interchangeably. An apparatus, system, or method that “comprises A, B, and C” includes A, B, and C, but also can include other components (e.g., D) as well. That is, the apparatus, system, or method is not limited to components A, B, and C.

Although the subject matter has been described in language specific to structural features and/or methodological acts, it is to be understood that the subject matter defined in the appended claims is not necessarily limited to the specific features or acts described.

While the example clauses included below may correspond to one or more particular implementations described above, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

A. A system, comprising: one or more processors; a non-transitory computer-readable medium having instructions stored thereon that, when executed by the one or more processors, cause the one or more processors to perform operations comprising: generating a software build artifact by using a first automated pipeline, the software build artifact comprising a build file of a legacy software package that operates in a first computing environment; generating a release artifact by using a second automated pipeline, the release artifact comprising a configuration of a server system in a second computing environment; installing the software build artifact on the release artifact to generate a picture of the legacy software on the server system; and hosting the legacy software through a virtual machine scale set by deploying one or more instances of the picture in a target computing environment.

B. The system of paragraph A, wherein the legacy software package is subject to one or more quality control systems (QCS) and alterations to underlying code of the legacy software package are limited by the QCS.

C. The system of paragraph A or B, wherein the first computing environment comprises a local server computing environment.

D. The system of any of claims A-C, wherein the target computing environment comprises a cloud computing environment.

E. The system of any of claims A-D, wherein generating the software build artifact comprises maintaining configuration control of the legacy software without changes that would violate a quality control system (QCS).

F. The system of any of claims A-E, wherein the legacy software is executed on a legacy virtual machine in the first computing environment and wherein hosting the legacy software comprises hosting multiple instances of the legacy software in an operating plane.

G. The system of any of claims A-F, wherein the operating plane is managed by an application gateway.

H. A method, comprising: generating a software build artifact by using a first automated pipeline, the software build artifact comprising a build file of a legacy software package that operates in a first computing environment; generating a release artifact by using a second automated pipeline, the release artifact comprising a configuration of a server system in a second computing environment; installing the software build artifact on the release artifact to generate a picture of the legacy software on the server system; and hosting the legacy software through a virtual machine scale set by deploying one or more instances of the picture in a target computing environment.

I. The method of paragraph H, wherein the legacy software package is subject to one or more quality control systems (QCS) and alterations to underlying code of the legacy software package are limited by the QCS.

J. The method of paragraph H or I, wherein generating the software build artifact comprises maintaining configuration control of the legacy software without changes that would violate a quality control system (QCS).

K. The method of any of claims H-J, wherein the first computing environment comprises a local server computing environment.

L. The method of any of claims H-K, wherein the target computing environment comprises a cloud computing environment.

M. The method of any of claims H-L, wherein the legacy software is executed on a legacy virtual machine in the first computing environment and wherein hosting the legacy software comprises hosting multiple instances of the legacy software in an operating plane.

N. The method of paragraph M, wherein the operating plane is managed by an application gateway that creates instances of the picture.

O. The method of paragraph N, wherein the instances of the picture are hosted in a virtual machine scale set to provide parallel processing and computing power for the legacy software.

P. A device, comprising: at least one processor; and memory storing instructions that, when executed by the at least one processor, cause the at least one processor to perform operations comprising: generating a software build artifact by using a first automated pipeline, the software build artifact comprising a build file of a legacy software package that operates in a first computing environment; generating a release artifact by using a second automated pipeline, the release artifact comprising a configuration of a server system in a second computing environment; installing the software build artifact on the release artifact to generate a picture of the legacy software on the server system; and hosting the legacy software through a virtual machine scale set by deploying one or more instances of the picture in a target computing environment.

Q. The device of paragraph P, wherein the legacy software package is subject to one or more quality control systems (QCS) and alterations to underlying code of the legacy software package are limited by the QCS.

R. The device of paragraph P or Q, wherein the legacy software is executed on a legacy virtual machine in the first computing environment and wherein hosting the legacy software comprises hosting multiple instances of the legacy software in an operating plane.

S. The device of paragraph R, wherein the operating plane is managed by an application gateway that creates instances of the picture.

T. The device of paragraph S, wherein the instances of the picture are hosted in a virtual machine scale set to provide parallel processing and computing power for the legacy software.

What is claimed is:

1. A system, comprising:
one or more processors;
a non-transitory computer-readable medium having instructions stored thereon that, when executed by the one or more processors, cause the one or more processors to perform operations comprising:
generating a software build artifact by using a first automated pipeline, the software build artifact comprising a build file of a legacy software package that operates in a first computing environment;
generating a release artifact by using a second automated pipeline, the release artifact comprising a configuration of a server system in a second computing environment;
installing the software build artifact on the release artifact to generate a picture of the legacy software on the server system; and
hosting the legacy software through a virtual machine scale set by deploying one or more instances of the picture in a target computing environment.

2. The system of claim 1, wherein the legacy software package is subject to one or more quality control systems (QCS) and alterations to underlying code of the legacy software package are limited by the QCS.

3. The system of claim 1, wherein the first computing environment comprises a local server computing environment.

4. The system of claim 1, wherein the target computing environment comprises a cloud computing environment.

5. The system of claim 1, wherein generating the software build artifact comprises maintaining configuration control of the legacy software without changes that would violate a quality control system (QCS).

6. The system of claim 1, wherein the legacy software is executed on a legacy virtual machine in the first computing environment and wherein hosting the legacy software comprises hosting multiple instances of the legacy software in an operating plane.

7. The system of claim 1, wherein the operating plane is managed by an application gateway.

8. A method, comprising:
generating a software build artifact by using a first automated pipeline, the software build artifact comprising a build file of a legacy software package that operates in a first computing environment;
generating a release artifact by using a second automated pipeline, the release artifact comprising a configuration of a server system in a second computing environment;
installing the software build artifact on the release artifact to generate a picture of the legacy software on the server system; and
hosting the legacy software through a virtual machine scale set by deploying one or more instances of the picture in a target computing environment.

9. The method of claim 8, wherein the legacy software package is subject to one or more quality control systems (QCS) and alterations to underlying code of the legacy software package are limited by the QCS.

10. The method of claim 8, wherein generating the software build artifact comprises maintaining configuration control of the legacy software without changes that would violate a quality control system (QCS).

11. The method of claim 8, wherein the first computing environment comprises a local server computing environment.

12. The method of claim 8, wherein the target computing environment comprises a cloud computing environment.

13. The method of claim 8, wherein the legacy software is executed on a legacy virtual machine in the first computing environment and wherein hosting the legacy software comprises hosting multiple instances of the legacy software in an operating plane.

14. The method of claim 13, wherein the operating plane is managed by an application gateway that creates instances of the picture.

15. The method of claim 14, wherein the instances of the picture are hosted in a virtual machine scale set to provide parallel processing and computing power for the legacy software.

16. A device, comprising:
at least one processor; and
memory storing instructions that, when executed by the at least one processor, cause the at least one processor to perform operations comprising:
generating a software build artifact by using a first automated pipeline, the software build artifact comprising a build file of a legacy software package that operates in a first computing environment;
generating a release artifact by using a second automated pipeline, the release artifact comprising a configuration of a server system in a second computing environment;
installing the software build artifact on the release artifact to generate a picture of the legacy software on the server system; and
hosting the legacy software through a virtual machine scale set by deploying one or more instances of the picture in a target computing environment.

17. The device of claim 16, wherein the legacy software package is subject to one or more quality control systems (QCS) and alterations to underlying code of the legacy software package are limited by the QCS.

18. The device of claim 16, wherein the legacy software is executed on a legacy virtual machine in the first computing environment and wherein hosting the legacy software comprises hosting multiple instances of the legacy software in an operating plane.

19. The device of claim 18, wherein the operating plane is managed by an application gateway that creates instances of the picture.

20. The device of claim 19, wherein the instances of the picture are hosted in a virtual machine scale set to provide parallel processing and computing power for the legacy software.
